(19) United States
(12) Patent Application Publication
(10) Pub. No.: US 2022/0328239 A1
(43) Pub. Date: Oct. 13, 2022

(54) COIL COMPONENT

(71) Applicant: Murata Manufacturing Co., Ltd., Kyoto-fu (JP)

(72) Inventors: Takuma SAGARA, Nagaokakyo-shi (JP); Kota TAKAYAMA, Nagaokakyo-shi (JP); Masashi MIYAMOTO, Nagaokakyo-shi (JP); Shingo NAKAMOTO, Nagaokakyo-shi (JP); Kaori TAKEZAWA, Nagaokakyo-shi (JP)

(73) Assignee: Murata Manufacturing Co., Ltd., Kyoto-fu (JP)

(21) Appl. No.: 17/714,828

(22) Filed: Apr. 6, 2022

(30) Foreign Application Priority Data
Apr. 8, 2021 (JP) 2021-065964

(51) Int. Cl. H01F 27/29; H01F 27/24; H01F 27/28; H01F 27/30

(52) U.S. Cl. CPC H01F 27/29; H01F 27/24; H01F 27/2823; H01F 27/306

(57) ABSTRACT

In a coil component, a first end of a wire is connected to a first terminal electrode. Part of the wire extends in a spiral shape around a peripheral surface of a winding core portion with a center axis as an axis of helix. A region of the wire from a first point at which the wire is connected to the first terminal electrode to a second point at which the wire has been wound through one turn around the center axis is referred to as a first wire range. Within the first wire range, the wire has a first connection point at which the wire is connected to a top plate via adhesive. The wire is separated from the peripheral surface of the winding core portion at the first connection point.

### CROSS-REFERENCE TO RELATED APPLICATION

This application claims benefit of priority to Japanese Patent Application No. 2021-065964, filed Apr. 8, 2021, the entire content of which is incorporated herein by reference.

### BACKGROUND

### Technical Field

The present disclosure relates to a coil component.

### Background Art

A coil component described in Japanese Unexamined Patent Application Publication No. 2018-010999 includes a winding core portion having a center axis, a first flange portion, a second flange portion, and a wire. The winding core portion has a quadrangular columnar shape. The first flange portion is connected to a first end of the winding core portion. The first flange portion projects outwardly from a peripheral surface of the winding core portion in a radial direction centered on the center axis. The second flange portion is connected to a second end of the winding core portion. The second flange portion projects outwardly from the peripheral surface of the winding core portion in a radial direction centered on the center axis. The wire extends helically along the peripheral surface of the winding core portion with the center axis of the winding core portion as an axis of helix. In addition, the wire extends so that turns thereof are adjacent to each other in a direction along the center axis in the part of the wire extending helically.

In the coil component described in Japanese Unexamined Patent Application Publication No. 2018-010999, the turns of a single wire are adjacent to each other in a direction along the center axis. Therefore, parasitic capacitances are generated between turns of the wire. If the parasitic capacitances between the turns are excessively large, there is a risk that the characteristics of the coil component will be degraded. More specifically, the impedance in a high-frequency band will be degraded.

### SUMMARY

Accordingly, an aspect of the present disclosure provides a coil component that includes a core including a winding core portion having a center axis, a first flange portion connected to a first end, in a direction along the center axis, of the winding core portion and projecting outwardly from a peripheral surface of the winding core portion in a radial direction centered on the center axis, and a second flange portion connected to a second end of the winding core portion. The second end is on an opposite side from the first end, and projects outwardly from the peripheral surface of the winding core portion in the radial direction centered on the center axis. The coil component further includes a wire having a part that extends helically along the peripheral surface of the winding core portion with the center axis being an axis of helix; a first terminal electrode connected to a first end of the wire and provided on a surface of the first flange portion; a second terminal electrode connected to a second end of the wire and provided on a surface of the second flange portion; and a top plate that extends through a longer range in a direction along the center axis than the winding core portion and is connected to the first flange portion and the second flange portion. When an axis perpendicular to the center axis is referred to as a perpendicular axis and one direction among two directions along the perpendicular axis is referred to as a positive direction and a direction opposite to the positive direction is referred to as a negative direction, the top plate is connected to an end of the first flange portion on the positive direction side and to an end of the second flange portion on the positive direction side, and the first terminal electrode is located on an end of a surface of the first flange portion on the negative direction side. When a region of the wire from a point where the wire is connected to the first terminal electrode to a point at which the wire has been wound through one turn around the center axis is referred to as a first wire range, the wire has a connection point to the top plate inside the first wire range, and the wire is separated from the peripheral surface of the winding core portion at the connection point.

With the above-described configuration, the region near the connection point of the wire to the top plate is separated from the part of the wire that extends along the peripheral surface of the winding core portion. Therefore, a parasitic capacitance generated in the vicinity of the connection point of the wire to the top plate can be reduced. As a result, degradation of the characteristics of the coil component caused by the parasitic capacitance can be suppressed.

Accordingly, an aspect of the present disclosure provides a coil component including a core including a winding core portion having a center axis, a first flange portion connected to a first end, in a direction along the center axis, of the winding core portion and projecting outwardly from a peripheral surface of the winding core portion in a radial direction centered on the center axis, and a second flange portion connected to a second end of the winding core portion. The second end is on an opposite side from the first end, and projects outwardly from the peripheral surface of the winding core portion in the radial direction centered on the center axis. The coil component further includes a wire having a part that extends helically along the peripheral surface of the winding core portion with the center axis being an axis of helix; a first terminal electrode connected to a first end of the wire and provided on a surface of the first flange portion; a second terminal electrode connected to a second end of the wire and provided on a surface of the second flange portion; and a top plate that extends through a longer range in a direction along the center axis than the winding core portion and is connected to the first flange portion and the second flange portion. When an axis perpendicular to the center axis is referred to as a perpendicular axis and one direction among two directions along the perpendicular axis is referred to as a positive direction and a direction opposite to the positive direction is referred to as a negative direction, the top plate is connected to an end of the first flange portion on the positive direction side and to an end of the second flange portion on the positive direction side, and the first terminal electrode is located on an end of a surface of the first flange portion on the negative direction side. When a region of the wire from a point where the wire is connected to the first terminal electrode to a point at which the wire has been wound through one turn around the center axis is referred to as a first wire range, the wire has a contact point with the top plate inside the first wire range, and the wire is separated from the peripheral surface of the winding core portion at the contact point.

With the above-described configuration, the region near the contact point of the wire with the top plate is separated from the part of the wire that extends along the peripheral surface of the winding core portion. Therefore, a parasitic capacitance generated in the vicinity of the contact point of the wire with the top plate can be reduced. As a result, degradation of the characteristics of the coil component caused by the parasitic capacitance can be suppressed.

Accordingly, an aspect of the present disclosure provides a coil component including a core including a winding core portion having a center axis, a first flange portion connected to a first end, in a direction along the center axis, of the winding core portion and projecting outwardly from a peripheral surface of the winding core portion in a radial direction centered on the center axis, and a second flange portion connected to a second end of the winding core portion. The second end is on an opposite side from the first end, and projects outwardly from the peripheral surface of the winding core portion in the radial direction centered on the center axis. The coil component further includes a wire having a part that extends helically along the peripheral surface of the winding core portion with the center axis being an axis of helix; a first terminal electrode connected to a first end of the wire and provided on a surface of the first flange portion; and a second terminal electrode connected to a second end of the wire and provided on a surface of the second flange portion. When an axis perpendicular to the center axis is referred to as a perpendicular axis and one direction among two directions along the perpendicular axis is referred to as a positive direction and a direction opposite to the positive direction is referred to as a negative direction, the first terminal electrode is located on an end of a surface of the first flange portion on the negative direction side. When a region of the wire from a point where the wire is connected to the first terminal electrode to a point at which the wire has been wound through one turn around the center axis is referred to as a first wire range, the wire is separated from the winding core portion throughout all of the positive direction side of the first wire range when looking along the center axis.

With this configuration, the wire is separated from the winding core portion throughout the entirety of the positive direction side of the first wire range of the wire when looking along the center axis. Therefore, a generated parasitic capacitance can be reduced across a correspondingly wide range. As a result, degradation of the characteristics of the coil component caused by the parasitic capacitance can be suppressed.

A reduction in impedance in a high-frequency band of a coil component caused by a parasitic capacitance can be suppressed.

### BRIEF DESCRIPTION OF THE DRAWINGS

FIG. 1 is a side view of a coil component;

FIG. 2 is a bottom view of the coil component in FIG. 1;

FIG. 3 is a sectional view taken along line 3-3 in FIG. 2;

FIG. 4 is a sectional view taken along line 4-4 in FIG. 3;

FIG. 5 is a bottom view of a top plate;

FIG. 6 is an explanatory diagram for describing a thick film part;

FIG. 7 is an explanatory diagram for describing a thin-film part;

FIG. 8 is an explanatory diagram for describing a first wire range of a wire;

FIG. 9 is an explanatory diagram for describing a second wire range of a wire;

FIG. 10 is a side view of a coil component of a modification; and

FIG. 11 is a side view of a coil component of a modification.

### DETAILED DESCRIPTION

Coil Component of Embodiment

Hereafter, a coil component according to an embodiment will be described. In the drawings, constituent elements may be illustrated in an enlarged manner for ease of understanding. The dimensional ratios of the constituent elements may differ from the actual ratios or may differ from the ratios in other drawings. Furthermore, hatching is used in the sectional views, but the hatching of some constituent elements may be omitted for ease of understanding.

Overall Configuration

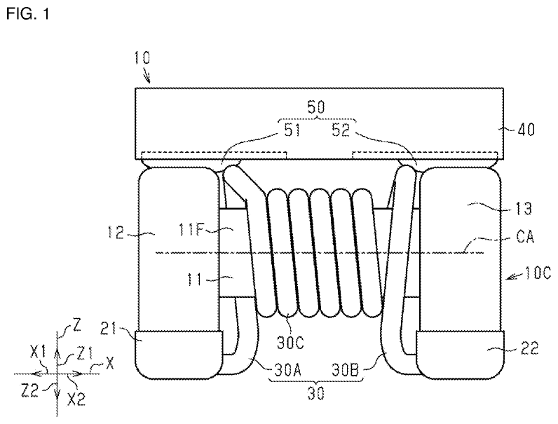

As illustrated in FIG. 1, a coil component 10 includes a core 10C. The core 10C includes a winding core portion 11. The winding core portion 11 has a quadrangular columnar shape. Therefore, the winding core portion 11 has a center axis CA and extends in a direction along the center axis CA. Furthermore, the winding core portion 11 has a peripheral surface 11F that surrounds the center axis CA.

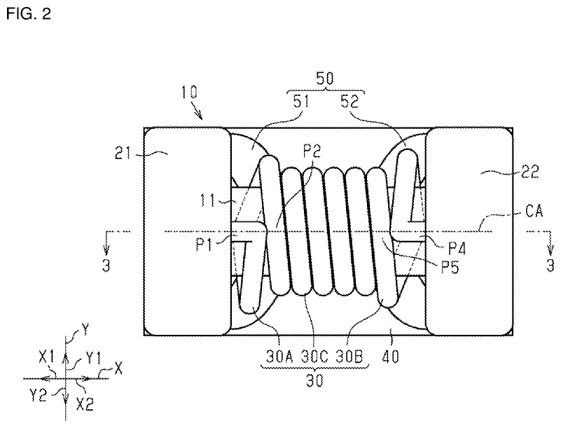

In the following description, a first axis X is an axis that extends in a direction along the center axis CA. In addition, as illustrated in FIG. 2, a second axis Y is an axis that extends parallel to any particular side among four sides making up the quadrangular shape of a cross section of the winding core portion 11 perpendicular to the center axis CA. Then, as illustrated in FIG. 1, a third axis Z is an axis that is perpendicular to the first axis X and the second axis Y. In other words, the third axis Z is a perpendicular axis that is perpendicular to the center axis CA. In addition, one direction along the first axis X is referred to as a first positive direction X1 and the other direction along the first axis X is referred to as a first negative direction X2. In addition, as illustrated in FIG. 2, one direction along the second axis Y is referred to as a second positive direction Y1 and the other direction along the second axis Y is referred to as a second negative direction Y2. Furthermore, as illustrated in FIG. 1, one direction along the third axis Z is referred to as a third positive direction Z1 and the other direction along the third axis Z is referred to as a third negative direction Z2. In other words, a direction opposite to the third positive direction Z1 is the third negative direction Z2.

As illustrated in FIG. 1, the core 10C further includes a first flange portion 12 and a second flange portion 13. The first flange portion 12 is connected to a first end of the winding core portion 11, the first end being the end of the winding core portion 11 on the first positive direction X1 side. The first flange portion 12 projects outwardly from the peripheral surface 11F of the winding core portion 11 in a radial direction centered on the center axis CA. As illustrated in FIG. 2, the first and second flange portions 12 and 13 project from the peripheral surface 11F in the second positive direction Y1 and the second negative direction Y2 by the same amount. However, as illustrated in FIG. 1, the first and second flange portions 12 and 13 protrude from the peripheral surface 11F of the winding core portion 11 by a greater amount in the third negative direction Z2 than in the third positive direction Z1. In other words, the center of the first flange portion 12 in a direction along the third axis Z is shifted towards the third negative direction Z2 from the center axis CA of the winding core portion 11.

The second flange portion 13 is connected to a second end of the winding core portion 11, the second end being the end of the winding core portion 11 on the first negative direction X2 side. The second flange portion 13 is shaped so as to be symmetrical with the first flange portion 12 in a direction along the first axis X with the winding core portion 11 interposed therebetween. Cross sections of the first flange portion 12 and the second flange portion 13 perpendicular to the center axis CA of the winding core portion 11 have quadrangular shapes.

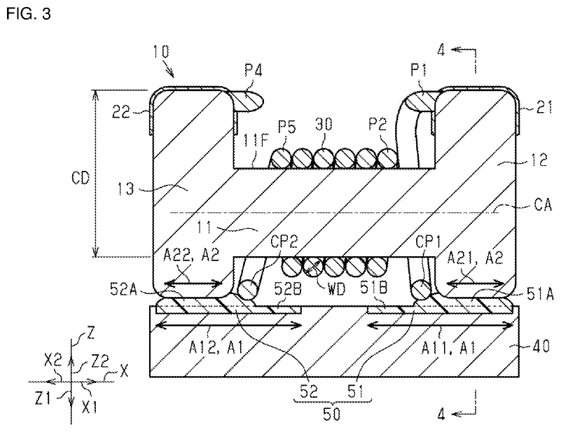

The material constituting the core 10C is a non-conductive material. The material of the core 10C is, for example, alumina, a nickel-zinc ferrite, a resin, or a mixture of these materials. Furthermore, as illustrated in FIG. 3, a dimension from an end of the winding core portion 11 on the third positive direction Z1 side to an end of the first flange portion 12 on the third negative direction Z2 side is referred to as a core dimension CD. Here, the core dimension CD is, for example, 1 mm or less.

The coil component 10 has a first terminal electrode 21 and a second terminal electrode 22. As illustrated in FIG. 3, the first terminal electrode 21 is located on a surface of the first flange portion 12. Specifically, the first terminal electrode 21 is located on a surface of the first flange portion 12 at an end in the third negative direction Z2.

The second terminal electrode 22 is located on a surface of the second flange portion 13. Specifically, the second terminal electrode 22 is located on a surface of the second flange portion 13 at an end in the third negative direction Z2. The first terminal electrode 21 and the second terminal electrode 22 each consist of a metal layer composed of silver and a plating layer composed of copper, nickel, or tin applied to the surface of the metal layer. In this embodiment, the surface of the coil component 10 on which the first terminal electrode 21 and the second terminal electrode 22 are located, that is, the surface facing in the third negative direction Z2, is the surface that will face a substrate when the coil component 10 is mounted on a substrate.

As illustrated in FIG. 1, the coil component 10 includes a wire 30. A first end of the wire 30 is connected to the first terminal electrode 21. A second end of the wire 30 is connected to the second terminal electrode 22. Part of the wire 30 extends in a spiral shape along the peripheral surface 11F of the winding core portion 11 with the center axis CA acting as the axis of helix.

As illustrated in FIG. 3, the diameter of the wire 30 is referred to as a wire diameter WD. The wire diameter WD is greater than or equal to 5% and less than or equal to 20% (i.e., from 5% to 20%) of the core dimension CD. The wire 30 will be described in detail later.

The coil component 10 has a top plate 40. The top plate 40 has a rectangular plate-like shape that is longer in a direction along the first axis X than in a direction along the second axis Y. The top plate 40 is connected to an end of the core 10C that is on the third positive direction Z1 side. In other words, the top plate 40 is connected to the end of the core 10C that is on the opposite side from the end where the first terminal electrode 21 and the second terminal electrode 22 are disposed. The top plate 40 is connected to the core 10C so as to span between the end surface of the first flange portion 12 on the third positive direction Z1 side and the end surface of the second flange portion 13 on the third positive direction Z1 side. Therefore, the dimension of the top plate 40 in a direction along the first axis X is larger than the dimension of the winding core portion 11 in a direction along the first axis X. In other words, the top plate 40 extends through a longer range in a direction along the center axis CA than the winding core portion 11. Furthermore, as illustrated in FIG. 2, the dimension of the top plate 40 in a direction along the second axis Y is substantially the same as the dimension of the first flange portion 12 in a direction along the second axis Y and the dimension of the second flange portion 13 in a direction along the second axis Y.

Next, the surface roughness of the core 10C and the surface roughness of the top plate 40 will be described. The following values were measured on the surface of the top plate 40 facing in the third negative direction Z2 and the surface of the first flange portion 12 facing in the third positive direction Z1.

For the surface roughness of core 10C, a developed interfacial area ratio Sdr of the surface of core 10C is 0.08. An arithmetic mean value Spc of peak points TP of the surface of the core 10C is 2160. An arithmetic mean height Sa of the core 10C is 0.40. These values were measured using a non-contact method according to standard ISO 25178.

On the other hand, for the surface roughness of the top plate 40, a developed interfacial area ratio Sdr of the surface of the top plate 40 is 0.19. An arithmetic mean value Spc of peak points TP of the surface of the top plate 40 is 2860. An arithmetic mean height Sa of the surface of the top plate 40 is 0.28. Therefore, a developed interfacial area ratio Sdr of the surface of the top plate 40 is greater than or equal to 0.15 and less than or equal to 0.50 (i.e., from 0.15 to 0.50). Furthermore, the developed interfacial area ratio Sdr of the surface of the top plate 40 is larger than the developed interfacial area ratio Sdr of the surface of the core 10C.

Thus, the surfaces of the core 10C and the top plate 40 both have a certain roughness. The surface of the top plate 40 is rougher than the surface of the core 10C. As illustrated in FIG. 1, the top plate 40 is connected to the first flange portion 12 and the second flange portion 13 via an adhesive 50. However, the adhesive 50 does not contact the winding core portion 11. The adhesive 50 is divided into a first adhesive part 51 that connects the top plate 40 and the first flange portion 12 to each other and a second adhesive part 52 that connects the top plate 40 and the second flange portion 13 to each other. The adhesive 50 is a thermosetting adhesive, and is composed of, for example, an epoxy resin.

First Adhesive Part and Second Adhesive Part

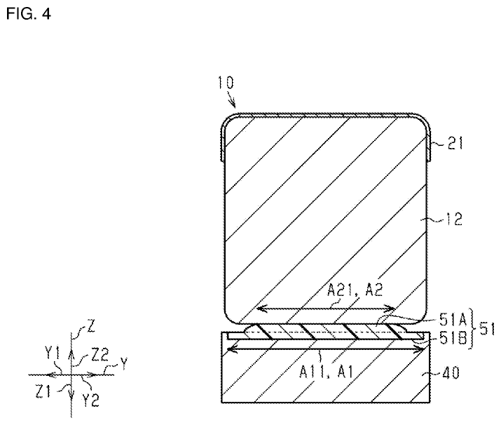

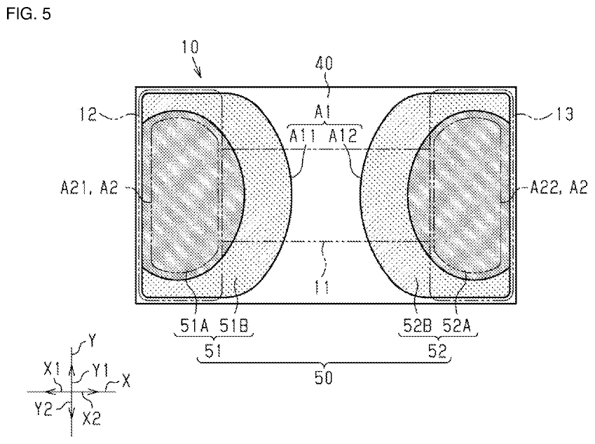

As illustrated in FIG. 4, the first adhesive part 51 connects the first flange portion 12 and the top plate 40 to each other. In addition, as illustrated in FIG. 5, on a surface of the top plate 40 that faces in the third negative direction Z2, the first adhesive part 51 is located toward the first positive direction X1 side with respect to the center of the surface in a direction along the first axis X.

Then, as illustrated in FIGS. 3 and 4, the first adhesive part 51 spreads across a first area A11 on the surface of the top plate 40 facing in the third negative direction Z2. As illustrated in FIG. 5, in the first area A11, the first adhesive part 51 includes a first thick film part 51A and a first thin film part 51B.

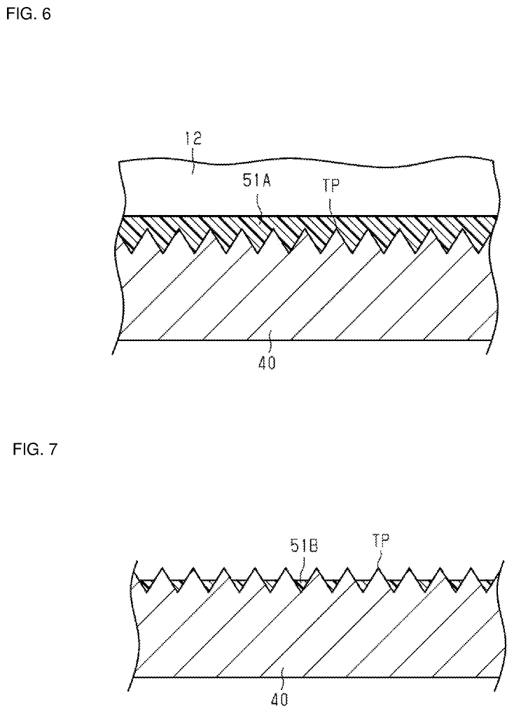

As illustrated in FIG. 6, the first thick film part 51A is the part having a thickness that extends to a position farther from the surface than the peak points TP on the surface of the top plate 40 having roughness. On the surface of the top plate 40 that faces in the third negative direction Z2, the first thick film part 51A is located towards the first positive direction X1 side relative to the center of the top plate 40 in a direction along the first axis X.

On the other hand, the first thin film part 51B is the part not having a thickness extending up to the peak points TP on the surface of the top plate 40 having roughness. In other words, as illustrated in FIG. 7, the first thin film part 51B spreads into valley parts between the peak points TP on the surface of the top plate 40 having roughness, but the peak points TP of the top plate 40 are not covered. In addition, as illustrated in FIG. 5, the first thin film part 51B surrounds the periphery of the first thick film part 51A when looking in a direction along the third axis Z. The edge of the first thin film part 51B on the first negative direction X2 side does not reach the center of the top plate 40 in a direction along the first axis X.

As illustrated in FIG. 4, the surface of the first flange portion 12 that faces in the third positive direction Z1 faces part of the first thin film part 51B of the first adhesive part 51. As illustrated in FIGS. 3 and 4, the first flange portion 12 is connected to the top plate 40 via part of the first thick film part 51A of the first adhesive part 51. Therefore, as illustrated in FIG. 5, a second area A21, which is the area where the adhesive 50 is present on the surface of the first flange portion 12, is smaller than the area where the first thick film part 51A is present in the first adhesive part 51. Therefore, the first area A11 is larger than the second area A21.

In addition, as illustrated in FIG. 3, the second adhesive part 52 spreads across a third area A12 out of the surface of the top plate 40 facing in the third negative direction Z2. As illustrated in FIG. 5, in the third area A12, the second adhesive part 52 includes a second thick film part 52A and a second thin film part 52B.

When looking in a direction along the third axis Z, the second adhesive part 52 has line symmetry with the first adhesive part 51 with an axis parallel to the second axis Y extending through the center of the top plate 40 in a direction along the first axis X serving as the axis of symmetry. Therefore, similarly to the first thick film part 51A, the second thick film part 52A is the part having a thickness that extends to a position farther from the surface than the peak points TP on the surface of the top plate 40 having roughness. On the surface of the top plate 40 that faces in the third negative direction Z2, the second thick film part 52A is located at an end towards the first negative direction X2 side relative to the center of the top plate 40 in a direction along the first axis X.

In addition, similarly to the first thin film part 51B, the second thin film part 52B is the part not having a thickness extending up to the peak points TP on the surface of the top plate 40 having roughness. In other words, the second thin film part 52B spreads into valley parts between the peak points TP on the surface of the top plate 40 having roughness, but the peak points TP of the top plate 40 are not covered. In addition, the second thin film part 52B surrounds the periphery of the second thick film part 52A when looking in a direction along the third axis Z. The edge of the second thin film part 52B in the first positive direction X1 does not reach the center of the top plate 40 in a direction along the first axis X. Therefore, the second thin film part 52B and the first thin film part 51B do not contact each other. In other words, the first area A11 is separated from the third area A12. When the area of the surface of the top plate 40 where the adhesive 50 is present is referred to as a first presence area A1, the first presence area A1 is the area consisting of the first area A11 and the third area A12.

As illustrated in FIG. 4, the surface of the second flange portion 13 that faces in the third positive direction Z1 faces part of the second thin film part 52B of the second adhesive part 52. In addition, as illustrated in FIG. 3, the second flange portion 13 is connected to the top plate 40 via part of the second thick film part 52A of the second adhesive part 52. Therefore, as illustrated in FIG. 5, a fourth area A22, which is an area where the adhesive 50 is present on the surface of the second flange portion 13, is smaller than the area where the second thick film part 52A is present in the second adhesive part 52. Therefore, the third area A12 is larger than the fourth area A22.

An area consisting of the second area A21 and the fourth area A22 is referred to as a second presence area A2. The first presence area A1 is larger than the second presence area A2. Specifically, the first presence area A1 is at least 1.1 times the size of the second presence area A2.

### Wire

Next, the wire 30 will be described in detail. As illustrated in FIG. 2, the first end of the wire 30 is connected to a surface of the first terminal electrode 21 that faces in the first negative direction X2. In addition, the first end of the wire 30 is located at the center of the first flange portion 12 in a direction along the second axis Y.

In addition, the second end of the wire 30 is connected to a surface of the second terminal electrode 22 that faces in the first positive direction X1. Furthermore, the second end of the wire 30 is located at the center of the second flange portion 13 in a direction along the second axis Y.

The wire 30 includes a first part 30A containing the first end, a second part 30B containing the second end, and a center part 30C, which is the part between the first part 30A and the second part 30B. The center part 30C of the wire 30 extends helically along the peripheral surface 11F of the winding core portion 11 with the center axis CA of the winding core portion 11 as the axis of helix. On the other hand, the first part 30A containing the first end of the wire 30 extends helically with the center axis CA as the axis of helix so as to be separated from the peripheral surface 11F. Similarly, the second part 30B containing the second end of the wire 30 extends helically with the center axis CA as the axis of helix so as to be separated from the peripheral surface 11F.

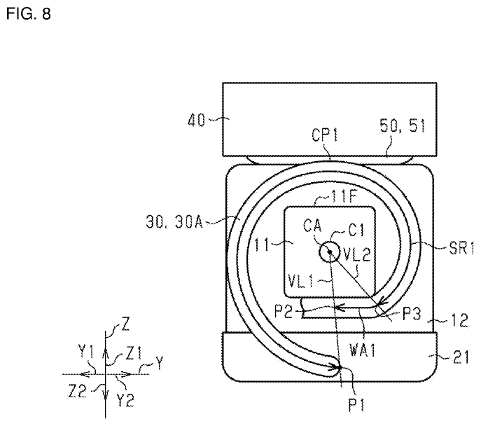

Here, as illustrated in FIG. 8, a region of the wire 30 from a first point P1 connected to the first terminal electrode 21 to a second point P2 at which the wire 30 has been wound through one turn around the center axis CA is referred to as a first wire range WA1.

The wire 30 extends in an arc shape so as to be separated from the peripheral surface 11F of the winding core portion 11 around the center axis CA of the winding core portion 11 throughout most of the first wire range WA1. Here, within the first wire range WA1, a range in which the wire 30 is continuously separated from the peripheral surface 11F of the winding core portion 11 is referred to as a first no-contact range SR1. One end of the first no-contact range SR1 is the first point P1. The other end of the first no-contact range SR1 is a third point P3 which is the point at which the wire 30 first contacts the peripheral surface 11F when tracing the wire 30 from the first end of the wire 30. In other words, in FIG. 8, the first no-contact range SR1 is the range obtained when the wire 30 is traced from the first point P1 to the third point P3 in a clockwise direction. The third point P3 of the wire 30 corresponds to a fourth corner among four corners of the winding core portion 11 when the wire 30 is traced from the first end.

Here, when looking in a direction along the center axis CA, a straight line passing through the first point P1 and the center axis CA is referred to as a first virtual straight line VL1. In addition, when looking in a direction along the center axis CA, a straight line passing through the third point P3 and the center axis CA is referred to as a second virtual straight line VL2. At this time, among the angles formed between the first virtual straight line VL1 and the second virtual straight line VL2, the size of a first angle C1 that faces the first no-contact range SR1 is greater than or equal to 180 degrees and less than 360 degrees (i.e., from 180 degrees to 360 degrees). Therefore, in the first no-contact range SR1, the wire 30 is wound through a range greater than or equal to 180 degrees and less than 360 degrees (i.e., from 180 degrees to 360 degrees) and is continuously separated from the peripheral surface 11F throughout a range greater than or equal to 180 degrees and less than 360 degrees (i.e., from 180 degrees to 360 degrees).

In addition, when looking in a direction along the center axis CA, the first no-contact range SR1 is present throughout the entire range on the third positive direction Z1 side, i.e., on the side near the top plate 40 relative to the center axis CA along the peripheral surface 11F. In addition, when looking in a direction along the center axis CA, in the first no-contact range SR1, the wire 30 is separated from substantially the entirety of a surface facing in the second positive direction Y1 and substantially the entirety of a surface facing in the second negative direction Y2 out of the peripheral surface 11F.

Within the first no-contact range SR1, the wire 30 has a first connection point CP1 where the wire 30 is connected to the top plate 40 via the adhesive 50. Specifically, the first connection point CP1 of the wire 30 is connected to the top plate 40 via the first thick film part 51A of the first adhesive part 51 of the adhesive 50. Therefore, the wire 30 is separated from the peripheral surface 11F of the winding core portion 11 at the first connection point CP1.

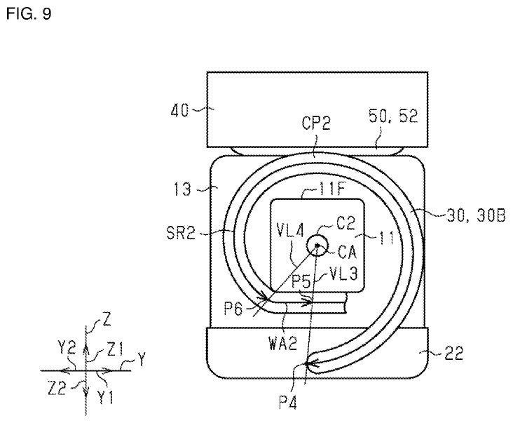

In addition, the second part 30B of the wire 30 has a structure that is symmetrical with the first part 30A of the wire 30. As illustrated in FIG. 9, a region of the wire 30 from a fourth point P4 connected to the second terminal electrode 22 to a fifth point P5 at which the wire 30 has been wound through one turn around the center axis CA is referred to as a second wire range WA2.

The wire 30 extends in an arc shape so as to be separated from the peripheral surface 11F of the winding core portion 11 around the center axis CA of the winding core portion 11 throughout most of the second wire range WA2. Here, within the second wire range WA2, a range in which the wire 30 is continuously separated from the peripheral surface 11F of the winding core portion 11 is referred to as a second no-contact range SR2. One end of the second no-contact range SR2 is the fourth point P4. The other end of the second no-contact range SR2 is a sixth point P6 which is the point at which the wire 30 first contacts the peripheral surface 11F when tracing the wire 30 from the second end of the wire 30. In other words, in FIG. 8, the second no-contact range SR2 is the range obtained when the wire 30 is traced from the second end of the wire 30 to the sixth point P6 in a counterclockwise direction. The sixth point P6 of the wire 30 corresponds to a fourth corner among four corners of the winding core portion 11 when the wire 30 is traced from the second end.

Here, when looking in a direction along the center axis CA, a straight line passing through the fourth point P4 and the center axis CA is referred to as a third virtual straight line VL3. In addition, when looking in a direction along the center axis CA, a straight line passing through the sixth point P6 and the center axis CA is referred to as a fourth virtual straight line VL4. At this time, among the angles formed between the third virtual straight line VL3 and the fourth virtual straight line VL4, the size of a second angle C2 that faces the second no-contact range SR2 is greater than or equal to 180 degrees and less than 360 degrees (i.e., from 180 degrees to 360 degrees). Therefore, in the second no-contact range SR2, the wire 30 is wound through a range greater than or equal to 180 degrees and less than 360 degrees (i.e., from 180 degrees to 360 degrees) and is continuously separated from the peripheral surface 11F throughout a range greater than or equal to 180 degrees and less than 360 degrees (i.e., from 180 degrees to 360 degrees).

In addition, when looking in a direction along the center axis CA, the second no-contact range SR2 is present throughout the entire range on the third positive direction Z1 side, i.e., on the side near the top plate 40 relative to the center axis CA along the peripheral surface 11F. In addition, when looking in a direction along the center axis CA, in the second no-contact range SR2, the wire 30 is separated from substantially the entirety of a surface facing in the second positive direction Y1 and substantially the entirety of a surface facing in the second negative direction Y2 out of the peripheral surface 11F.

Within the second no-contact range SR2, the wire 30 has a second connection point CP2 where the wire 30 is connected to the top plate 40 via the adhesive 50. Specifically, the second connection point CP2 of the wire 30 is connected to the top plate 40 via the second thick film part 52A of the second adhesive part 52 of the adhesive 50. Therefore, the wire 30 is separated from the peripheral surface 11F of the winding core portion 11 at the second connection point CP2.

### Actions of Embodiment

In the following description of actions and effects, the description given for the first part 30A of the wire 30 also applies to the second part 30B of the wire 30. Therefore, description for the second part 30B of the wire 30 is omitted.

As described above, in the first part 30A of the wire 30, the first connection point CP1 is separated from the peripheral surface 11F of the winding core portion 11. Therefore, as illustrated in FIG. 3, the turn of the first part 30A and the adjacent turn of the center part 30C do not contact each other and there is a space therebetween.

### Effects of Embodiment

1. If the turn of the first part 30A were to extend along the peripheral surface 11F of the winding core portion 11, the turn of the first part 30A would contact the adjacent turn of the center part 30C. When the turns closely contact each other in this way, a correspondingly large parasitic capacitance is generated due to the small distance between the turns.

In contrast, according to the above-described embodiment, the first connection point CP1 is separated from the peripheral surface 11F of the winding core portion 11 in the first part 30A of the wire 30. Therefore, as illustrated in FIG. 3, in the coil component 10, the turn of the first part 30A and the adjacent turn of the center part 30C do not contact each other. Compared to a case where the turns closely contact each other, the generated parasitic capacitance can be reduced by forming a space between the turn of the first part 30A and the adjacent turn of the center part 30C in this way. Thus, this reduction in the parasitic capacitance generated in the wire 30 leads to a reduction in impedance in the high-frequency band of the coil component 10 being suppressed.

2. According to the above-described embodiment, the wire 30 is fixed to the top plate 40 by the adhesive 50. Therefore, it is easier to maintain a state in which the wire 30 is separated from the peripheral surface 11F of the winding core portion 11.

3. According to the above-described embodiment, the first connection point CP1 of the wire 30 contacts the top plate 40 via the adhesive 50. Therefore, the adhesive 50, which is used to connect the top plate 40 to the first flange portion 12 and the second flange portion 13, can also be used to connect the wire 30 to the top plate 40. Therefore, there is no need to add a special material in order to connect the wire 30 to the top plate 40 and there is no need to adopt a special shape for the top plate 40.

4. According to the above-described embodiment, the wire diameter WD is greater than or equal to 5% and less than or equal to 20% (i.e., from 5% to 20%) of the core dimension CD. In other words, the wire diameter WD is comparatively larger than the core dimension CD. Therefore, when pressure bonding the first end of the wire 30 to the first terminal electrode 21 after winding the wire 30 under tension around the peripheral surface 11F of the winding core portion 11, the first no-contact range SR1 is easily provided in the first wire range WA1 by reducing the tension from that used when winding the wire 30.

5. According to the above-described embodiment, among angles formed between the first virtual straight line VL1 and the second virtual straight line VL2, the size of the first angle C1 that faces the first no-contact range SR1 is greater than or equal to 180 degrees and less than 360 degrees (i.e., from 180 degrees to 360 degrees). Therefore, the first no-contact range SR1 is wound through a range greater than or equal to 180 degrees and less than 360 degrees (i.e., from 180 degrees to 360 degrees). Therefore, since the first no-contact range SR1 is increased to a considerably wide range, the generated parasitic capacitance can be made smaller. This point similarly applies to the second angle C2.

In addition, in a case where the first no-contact range SR1 is 360 degrees or more and the wire 30 is connected to the first connection point CP1 at a plurality of turns, if the coating film of the wire 30 were damaged due to deterioration or the like, there would be a risk of a plurality of turns at the first connection point CP1 being electrically connected to each other through the adhesive 50. In this embodiment, in the first no-contact range SR1, since the wire 30 is wound through a range less than 360 degrees, a situation in which such a current unintentionally flows can be avoided.

6. According to the above-described embodiment, when looking in a direction along the center axis CA, the wire 30 is separated from substantially the entirety of a surface facing in the second positive direction Y1 and substantially the entirety of a surface facing in the second negative direction Y2 in the first no-contact range SR1. Therefore, when providing the first no-contact range SR1 so as to be continuous through a range of 180 degrees or more, it is easy to set the range so to include the first connection point CP1.

7. According to the above-described embodiment, the second connection point CP2 is located in the second part 30B of the wire 30, similarly to the first connection point CP1 being located in the first wire range WA1 in the first part 30A. Therefore, a generated parasitic capacitance can be reduced in the second part 30B containing the second end of the wire 30 as well as in the first part 30A containing the first end of the wire 30.

8. The first presence area A1 in which the adhesive 50 is present is larger than the second presence area A2 consisting of the area in which the adhesive 50 exists on the surface of the first flange portion 12 and the area in which the adhesive 50 exists on the surface of the second flange portion 13. Therefore, the adhesive 50 spreads beyond the areas on the surface of the top plate 40 that would be necessary for fixing the first flange portion 12 and the second flange portion 13 to the top plate 40. Thus, the adhesive 50 is present over a wide area on the surface of the top plate 40 and loads acting on the top plate 40 in directions along the third axis Z are more easily withstood in accordance with the amount of the adhesive 50 present. As a result, damage can be suppressed even when a load acts on the top plate 40.

The adhesive 50 does not contact the winding core portion 11. If the adhesive 50 were to reach the winding core portion 11, there would be a risk of a large part of the wire 30 contacting the adhesive 50 and the coating film of the wire 30 becoming deteriorated. Therefore, the occurrence of short circuits between adjacent parts of the wire caused by such deterioration can be avoided. In addition, compared to the minimum amount of adhesive needed to adhere the first flange portion 12 and the second flange portion 13 to the top plate 40, an excessively large amount of adhesive 50 is not needed.

9. According to the above-described embodiment, when looking in a direction along the third axis Z, the surface of the winding core portion 11 facing the top plate 40 overlaps part of the first area A11 and part of the third area Al2. In other words, parts of the first presence area A1 face the winding core portion 11. The winding core portion 11 is located in the center of the coil component 10 in a direction along the second axis Y. Therefore, since the top plate 40 is reinforced by the adhesive 50, even when a load acts on the top plate 40 when the coil component 10 is being mounted on a substrate, the top plate 40 is able to withstand the load.

10. According to the above-described embodiment, the size of the first presence area A1 is greater than or equal to 1.1 times the size of the second presence area A2. Provided that the area of the first presence area A1 is at least 1.1 times that of the second presence area A2, there will be an area of sufficient size to reinforce the top plate 40.

11. According to the above-described embodiment, the developed interfacial area ratio Sdr of the surface of the top plate 40 is greater than or equal to 0.15 and less than or equal to 0.50 (i.e., from 0.15 to 0.50). Therefore, when the adhesive 50 is applied to the surface of the top plate 40, the adhesive 50 readily spreads between fine protrusions and recesses on the top plate 40. Therefore, the adhesive 50 can be applied across a wide area on the surface of the top plate 40 without adopting a special method for applying the adhesive 50.

12. According to the above-described embodiment, the developed interfacial area ratio Sdr of the surface of the top plate 40 is larger than the developed interfacial area ratio Sdr of the surfaces of the first flange portion 12 and the second flange portion 13. Therefore, the adhesive 50 spreads more easily along the surface of the top plate 40 than along the surfaces of the first flange portion 12 and the second flange portion 13. As a result, the area across which the adhesive 50 spreads along the surface of the top plate 40 is easily made larger than the area across which the adhesive 50 spreads along the surfaces of the first flange portion 12 and the second flange portion 13.

### Other Embodiments

The above-described embodiment can be modified in the following ways. The above-described embodiment and the following modifications can be combined with each other to the extent that they are not technically inconsistent. In addition, a modification relating to the first positive direction X1 side of the coil component 10 with respect to the center in a direction along the first axis X is also applicable to the first negative direction X2 side of the coil component 10 with respect to the center in a direction along the first axis X.

The shape of the winding core portion 11 in the above-described embodiment is not limited to the example given in the above-described embodiment. For example, the shape may be a cylindrical shape or may be a polygonal columnar shape other than a quadrangular columnar shape.

In the above-described embodiment, a plurality of wires 30 may be wound around the winding core portion 11. The number of terminal electrodes may be appropriately adjusted in accordance with the number of wires 30. In the case where there are a plurality of wires 30, the first part 30A of at least one wire 30 may have the first connection point CP1.

In the above-described embodiment, the wire diameter WD may be less than 5% or greater than 20% of the core dimension CD. The core dimension CD and the wire diameter WD may be appropriately adjusted in accordance with the required characteristics and so on.

In the above-described embodiment, the center part 30C of the wire 30 extends in a spiral shape while in constant contact with the peripheral surface 11F of the winding core portion 11, but the center part 30C of the wire 30 may instead extend in a spiral shape with parts thereof separated from the peripheral surface 11F. For example, the wire 30 may contact the peripheral surface 11F only in the vicinity of the four corners of the winding core portion 11 when looking at the winding core portion 11 in a direction along the center axis CA. The wire 30 can be said to extend along the peripheral surface 11F even when the wire 30 intermittently contacts the peripheral surface 11F in this way.

In the above-described embodiment, the size of the first angle C1 may be less than 180 degrees. In other words, the first no-contact range SR1 may be less than 180 degrees. It is sufficient that at least the first connection point CP1 be included in the first no-contact range SR1. In addition, it is sufficient that part of the first no-contact range SR1 be included in the first wire range WA1 and part of the first no-contact range SR1 may be located outside the first wire range WA1. This also similarly applies to the second angle C2 and the second no-contact range SR2.

In the above-described embodiment, the first part 30A of the wire 30 may be separated from the peripheral surface 11F only at the surface facing in the third positive direction Z1 out of the peripheral surface 11F. In other words, the first part 30A may contact the surface facing in the third negative direction Z2 out of the peripheral surface 11F.

In the above-described embodiment, provided that at least the first connection point CP1 is connected to the top plate 40 and separated from the peripheral surface 11F, the second connection point CP2 may be omitted. In this case as well, a parasitic capacitance can be reduced at the first connection point CP1.

In the above-described embodiment, the shape of the top plate 40 is not limited to the example given in the embodiment. It is sufficient that the top plate 40 span between the first flange portion 12 and the second flange portion 13, and for example, a protrusion may be provided on the surface of the top plate 40 facing in the third negative direction Z2.

In the above-described embodiment, the first presence area A1 does not need to be provided in a part facing the winding core portion 11. For example, the first area A11 may be present only in a part facing the first flange portion 12 and the second area A21 may be present only on part of the surface of the first flange portion 12 facing in the third positive direction Z1.

In the above-described embodiment, the first area A11 and the third area A12 are separated from each other, but may instead contact each other to form a single first presence area A1. In addition, the first presence area A1 may consist of three or more separate areas.

In the above-described embodiment, the adhesive 50 may be entirely formed of thick film parts. For example, an appropriate amount of adhesive 50 may be applied to the entirety of the surface of the top plate 40 facing in the third negative direction Z2 so that the adhesive 50 is entirely formed of thick film parts.

In the above-described embodiment, the developed interfacial area ratio Sdr of the top plate 40 and the developed interfacial area ratio Sdr of the core 10C are not limited to the examples given in the embodiment. The developed interfacial area ratio Sdr of the top plate 40 may be less than 0.15 or greater than 0.50. In addition, the developed interfacial area ratio Sdr of the top plate 40 may be less than or equal to the developed interfacial area ratio Sdr of the core 10C. In this case, the adhesive 50 may be applied to the top plate 40 in advance in order to spread the adhesive 50 across a wide area on the surface of the top plate 40 facing in the third negative direction Z2. In addition, after placing the adhesive 50 on the top plate 40, the adhesive 50 may be spread using a tool or by using a spin coating process.

In the above-described embodiment, the size of the first presence area A1 may be less than 1.1 times the size of the second presence area A2. So long as variations are unlikely to occur in the area over which the adhesive 50 is applied during the process of applying the adhesive 50, the size of the first presence area A1 is highly likely to be larger than the size of the second presence area A2 even if the size of the first presence area A1 is less than 1.1 times the size of the second presence area A2.

In the above-described embodiment, the adhesive 50 is a thermosetting adhesive 50, but the type of adhesive 50 may be changed as appropriate. The adhesive 50 may consist of just resin or may be formed by adding an inorganic filler such as silica filler to resin. In the case where the adhesive 50 contains inorganic filler, the inorganic filler will tend to be present only in the thick film parts.

In the above-described embodiment, the size of the first presence area A1 may be less than or equal to the size of the second presence area A2. In this case, the first connection point CP1 may be connected to the top plate 40 using a different adhesive than the adhesive 50 connecting the core 10C and the top plate 40 to each other.

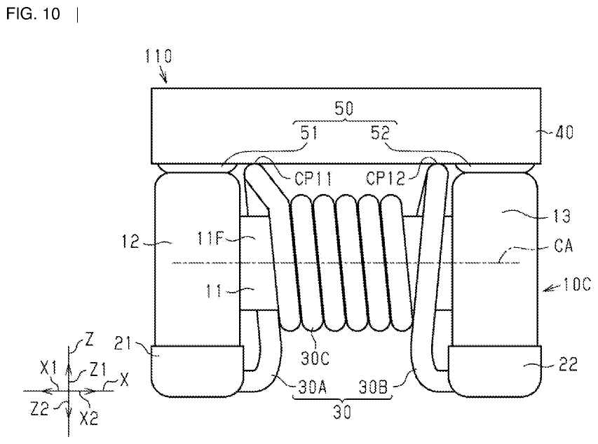

In the above-described embodiment, the adhesive 50 may be omitted and the core 10C and the top plate 40 may be integrated with each other. A first contact point CP11 may directly contact the top plate 40 with no other members therebetween as in a coil component 110 of a modification illustrated in FIG. 10. For example, in a state before the top plate 40 is connected to the core 10C, the wire 30 is wound so that the first part 30A of the wire 30 protrudes toward the third positive direction Z1 side when looking from the end of the first flange portion 12 in the third positive direction Z1. In this state, the top plate 40 is connected to the core 10C so that the first part 30A is pressed down by the top plate 40. The first part 30A presses against the top plate 40 with its own elastic force. As a result, the first part 30A has the first contact point CP11 directly connected to the top plate 40. Therefore, although the coil component 110 does not have the first connection point CP1, the coil component 110 does have the first contact point CP11. The wire 30 is separated from the peripheral surface 11F of the winding core portion 11 at the first contact point CP11. Similarly, although the coil component 10 does not have the second connection point CP2, the coil component 10 does have a second contact point CP12. The wire 30 is separated from the peripheral surface 11F of the winding core portion 11 at the second contact point CP12.

With this configuration, the wire 30 is separated from the peripheral surface 11F of the winding core portion 11 at the first contact point CP11. Therefore, in the coil component 10, the turn of the first part 30A and the adjacent turn of the center part 30C do not contact each other. Compared to a case where the turns closely contact each other, the generated parasitic capacitance can be reduced by forming a space between the turn of the first part 30A and the adjacent turn of the center part 30C in this way. Thus, this reduction in the parasitic capacitance generated in the wire 30 leads to a reduction in impedance in the high-frequency band of the coil component 10 being suppressed.

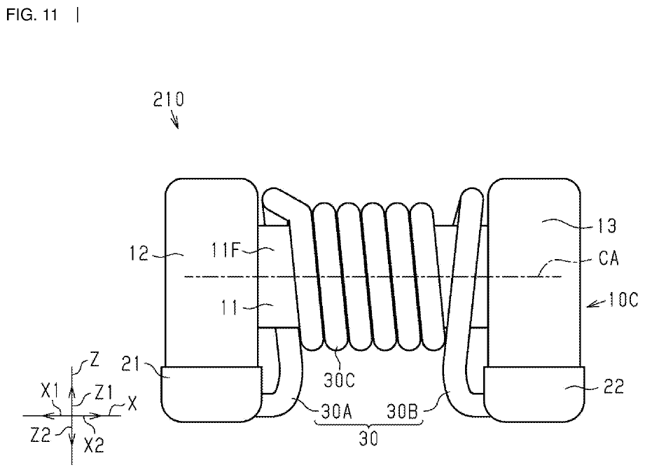

In the above-described embodiment, the first part 30A of the wire 30 does not have to have the first connection point CP1. In addition, in the case where the first part 30A does not have the first connection point CP1, the top plate 40 can be omitted as in a coil component 210 illustrated in FIG. 11. In the case of these modifications, the first no-contact range SR1 may be present throughout the entire range on the third positive direction Z1 side with respect to the center axis CA when looking in a direction along the center axis CA.

What is claimed is:

1. A coil component comprising:
a core including a winding core portion having a center axis, a first flange portion connected to a first end, in a direction along the center axis, of the winding core portion and projecting outwardly from a peripheral surface of the winding core portion in a radial direction centered on the center axis, and a second flange portion connected to a second end of the winding core portion, the second end being on an opposite side from the first end, and projecting outwardly from the peripheral surface of the winding core portion in the radial direction centered on the center axis;
a wire having a portion that extends helically along the peripheral surface of the winding core portion with the center axis as an axis of helix;
a first terminal electrode connected to a first end of the wire and on a surface of the first flange portion;
a second terminal electrode connected to a second end of the wire and on a surface of the second flange portion; and
a top plate that is a longer than the winding core portion in a direction along the center axis and that is attached to the first flange portion and the second flange portion,
wherein
when an axis perpendicular to the center axis is referred to as a perpendicular axis and one direction among two directions along the perpendicular axis is referred to as a positive direction and a direction opposite to the positive direction is referred to as a negative direction,
the top plate is attached to an end of the first flange portion on the positive direction and to an end of the second flange portion on the positive direction, and
the first terminal electrode is located on an end of the first flange portion on the negative direction, and
when a first wire range is defined as a region of the wire from a position where the wire is connected to the first terminal electrode to a position at which the wire is wound through one turn around the center axis,
the wire has a connection point to the top plate within the first wire range, and
the wire is separated from the peripheral surface of the winding core portion at the connection point.

2. The coil component according to claim 1, further comprising:
an adhesive that adheres the top plate to the first flange portion and the second flange portion,
wherein the adhesive is on a surface of the top plate that faces the first flange portion and a surface of the top plate that faces the second flange portion out of a surface of the top plate, and
the connection point is connected to the top plate via the adhesive.

3. The coil component according to claim 1, wherein
when a core dimension is defined as a dimension from an end of the winding core portion on the positive direction along the perpendicular axis to an end of the first flange portion on the negative direction along the perpendicular axis, and
a diameter of the wire is referred to as a wire diameter,
the wire diameter is from 5% to 20% of the core dimension.

4. The coil component according to claim 1, wherein
when a no-contact range is defined as a range in which the wire is separated from the peripheral surface of the winding core portion within the first wire range,
when viewed from a direction along the center axis, an angle corresponding to the no-contact range is 180 degrees or higher, wherein the angle is formed between a straight line passing through the center axis and a first end of the no-contact range in a direction of extension of the wire, and a straight line passing through the center axis and a second end of the no-contact range opposite to the first end in the direction of extension of the wire.

5. The coil component according to claim 1, wherein
the second terminal electrode is located on an end of the second flange portion on the negative direction, and
when a second wire range is defined as a region of the wire from a position where the wire is connected to the second terminal electrode to a position at which the wire is wound through one turn around the center axis, and
the connection point is referred to as a first connection point,
the wire has a second connection point to the top plate within the second wire range, and
the wire is separated from the peripheral surface of the winding core portion at the second connection point.

6. The coil component according to claim 2, wherein
when a core dimension is defined as a dimension from an end of the winding core portion on the positive direction along the perpendicular axis to an end of the first flange portion on the negative direction along the perpendicular axis, and
a diameter of the wire is referred to as a wire diameter,
the wire diameter is from 5% to 20% of the core dimension.

7. The coil component according to claim 2, wherein
when a no-contact range is defined as a range in which the wire is separated from the peripheral surface of the winding core portion within the first wire range,
when viewed from a direction along the center axis, an angle corresponding to the no-contact range is 180 degrees or higher, wherein the angle is formed between a straight line passing through the center axis and a first end of the no-contact range in a direction of extension of the wire, and a straight line passing through the center axis and a second end of the no-contact range opposite to the first end in the direction of extension of the wire.

8. The coil component according to claim 3, wherein
when a no-contact range is defined as a range in which the wire is separated from the peripheral surface of the winding core portion within the first wire range,
when viewed from a direction along the center axis, an angle corresponding to the no-contact range is 180 degrees or higher, wherein the angle is formed between a straight line passing through the center axis and a first end of the no-contact range in a direction of extension of the wire, and a straight line passing through the center axis and a second end of the no-contact range opposite to the first end in the direction of extension of the wire.

9. The coil component according to claim 6, wherein
when a no-contact range is defined as a range in which the wire is separated from the peripheral surface of the winding core portion within the first wire range,
when viewed from a direction along the center axis, an angle corresponding to the no-contact range is 180 degrees or higher, wherein the angle is formed between a straight line passing through the center axis and a first end of the no-contact range in a direction of extension of the wire, and a straight line passing through the center axis and a second end of the no-contact range opposite to the first end in the direction of extension of the wire.

10. The coil component according to claim 2, wherein
the second terminal electrode is located on an end of the second flange portion on the negative direction, and
when a second wire range is defined as a region of the wire from a position where the wire is connected to the second terminal electrode to a position at which the wire is wound through one turn around the center axis, and
the connection point is referred to as a first connection point,
the wire has a second connection point to the top plate within the second wire range, and
the wire is separated from the peripheral surface of the winding core portion at the second connection point.

11. The coil component according to claim 3, wherein
the second terminal electrode is located on an end of the second flange portion on the negative direction, and
when a second wire range is defined as a region of the wire from a position where the wire is connected to the second terminal electrode to a position at which the wire is wound through one turn around the center axis, and
the connection point is referred to as a first connection point,
the wire has a second connection point to the top plate within the second wire range, and
the wire is separated from the peripheral surface of the winding core portion at the second connection point.

12. The coil component according to claim 4, wherein
the second terminal electrode is located on an end of the second flange portion on the negative direction, and
when a second wire range is defined as a region of the wire from a position where the wire is connected to the second terminal electrode to a position at which the wire is wound through one turn around the center axis, and
the connection point is referred to as a first connection point,
the wire has a second connection point to the top plate within the second wire range, and
the wire is separated from the peripheral surface of the winding core portion at the second connection point.

13. The coil component according to claim 6, wherein
the second terminal electrode is located on an end of the second flange portion on the negative direction, and
when a second wire range is defined as a region of the wire from a position where the wire is connected to the second terminal electrode to a position at which the wire is wound through one turn around the center axis, and
the connection point is referred to as a first connection point,
the wire has a second connection point to the top plate within the second wire range, and
the wire is separated from the peripheral surface of the winding core portion at the second connection point.

14. The coil component according to claim 7, wherein
the second terminal electrode is located on an end of the second flange portion on the negative direction, and
when a second wire range is defined as a region of the wire from a position where the wire is connected to the second terminal electrode to a position at which the wire is wound through one turn around the center axis, and
the connection point is referred to as a first connection point,
the wire has a second connection point to the top plate within the second wire range, and
the wire is separated from the peripheral surface of the winding core portion at the second connection point.

15. The coil component according to claim 8, wherein
the second terminal electrode is located on an end of the second flange portion on the negative direction, and
when a second wire range is defined as a region of the wire from a position where the wire is connected to the second terminal electrode to a position at which the wire is wound through one turn around the center axis, and
the connection point is referred to as a first connection point,
the wire has a second connection point to the top plate within the second wire range, and
the wire is separated from the peripheral surface of the winding core portion at the second connection point.

16. The coil component according to claim 9, wherein
the second terminal electrode is located on an end of the second flange portion on the negative direction, and
when a second wire range is defined as a region of the wire from a position where the wire is connected to the second terminal electrode to a position at which the wire is wound through one turn around the center axis, and
the connection point is referred to as a first connection point,
the wire has a second connection point to the top plate within the second wire range, and
the wire is separated from the peripheral surface of the winding core portion at the second connection point.

17. A coil component comprising:
a core including a winding core portion having a center axis, a first flange portion connected to a first end, in a direction along the center axis, of the winding core portion and projecting outwardly from a peripheral surface of the winding core portion in a radial direction centered on the center axis, and a second flange portion connected to a second end of the winding core portion, the second end being on an opposite side from the first end, and projecting outwardly from the peripheral surface of the winding core portion in the radial direction centered on the center axis;
a wire having a portion that extends helically along the peripheral surface of the winding core portion with the center axis as an axis of helix;
a first terminal electrode connected to a first end of the wire and provided on a surface of the first flange portion;
a second terminal electrode connected to a second end of the wire and on a surface of the second flange portion; and
a top plate that is a longer than the winding core portion in a direction along the center axis and that is attached to the first flange portion and the second flange portion,
wherein
when an axis perpendicular to the center axis is referred to as a perpendicular axis and one direction among two directions along the perpendicular axis is referred to as a positive direction and a direction opposite to the positive direction is referred to as a negative direction,
the top plate is attached to an end of the first flange portion on the positive direction and to an end of the second flange portion on the positive direction, and
the first terminal electrode is located on an end of the first flange portion on the negative direction, and
when a first wire range is defined as a region of the wire from a position where the wire is connected to the first terminal electrode to a position at which the wire is wound through one turn around the center axis,
the wire has a contact point with the top plate within the first wire range, and
the wire is separated from the peripheral surface of the winding core portion at the contact point.

18. A coil component comprising:
a core including a winding core portion having a center axis, a first flange portion connected to a first end, in a direction along the center axis, of the winding core portion and projecting outwardly from a peripheral surface of the winding core portion in a radial direction centered on the center axis, and a second flange portion connected to a second end of the winding core portion, the second end being on an opposite side from the first end, and projecting outwardly from the peripheral surface of the winding core portion in the radial direction centered on the center axis;
a wire having a portion that extends helically along the peripheral surface of the winding core portion with the center axis being an axis of helix;
a first terminal electrode connected to a first end of the wire and on a surface of the first flange portion; and
a second terminal electrode connected to a second end of the wire and provided on a surface of the second flange portion;
wherein
when an axis perpendicular to the center axis is referred to as a perpendicular axis and one direction among two directions along the perpendicular axis is referred to as a positive direction and a direction opposite to the positive direction is referred to as a negative direction,
the first terminal electrode is located on an end of the first flange portion on the negative direction, and
when a first wire range is defined as a region of the wire from a position where the wire is connected to the first terminal electrode to a position at which the wire is wound through one turn around the center axis,
the wire is separated from the winding core portion throughout a range belonging to the positive direction side, when viewed from the center axis, of the first wire range.
